(19) United States
(12) Patent Application Publication
(10) Pub. No.: US 2016/0292614 A1
(43) Pub. Date: Oct. 6, 2016

(54) Skill Shift Visualization System

(71) Applicant: ADP, LLC, Roseland, NJ (US)

(72) Inventors: Agatha Kurjanowicz, Ottawa (CA); Dominic Gadoury, New York, NY (US)

(21) Appl. No.: 14/878,463

(22) Filed: Oct. 8, 2015

Related U.S. Application Data
(63) Continuation-in-part of application No. 14/679,231, filed on Apr. 6, 2015.

(51) Int. Cl. G06Q 10/06; G06F 3/0484; G06F 17/30

(52) U.S. Cl. CPC G06Q 10/06398; G06F 17/30572; G06F 3/04847

(57) ABSTRACT

A method for analyzing skills for people in an organization. A computer system identifies a change in the skills over time for a group of the people in the organization. The computer system identifies a trend in the skills over time based on the changes in the skills identified. The computer system displays a visualization of the trend in a graphical user interface on a display system. The visualization is a graphical representation of the trend enabling performing an operation to meet a metric for the organization.

### CROSS-REFERENCE TO RELATED APPLICATIONS

This application is a Continuation-in-Part (CIP) of the following patent application: entitled “Skill Identification System,” Ser. No. 14/679,231, filed Apr. 6, 2015, and attorney docket no. ES2015002-1.

This application is related to the following patent application: entitled “Skill Analyzer,” Ser. No. 14/708,816, filed May 11, 2015, and attorney docket no. ES2015002-2. Each of the aforementioned applications are assigned to the same assignee and incorporated herein by reference in their entirety.

### BACKGROUND INFORMATION

1. Field

The present disclosure relates generally to an improved computer system, and, in particular, to a method and apparatus for accessing information in a computer system. Still more particularly, the present disclosure relates to a method and apparatus for analyzing information about skills for an organization in a computer system.

2. Background

Information systems are used for many different purposes. For example, an information system may be used to process payroll to generate paychecks for employees in an organization. Additionally, an information system also may be used by a human resources department to maintain benefits and other records about employees. For example, a human resources department may manage health insurance, wellness plans, and other programs and organizations using an employee information system. As another example, a research department in the organization may use an information system to store and analyze information to research new products, analyze products, or for other suitable operations. As yet another example, an information system may be used to hire new employees, assign employees to projects, perform reviews for employees, and other suitable operations for the organization.

Currently used information systems include databases. These databases store information about the organization. For example, these databases store information about employees, products, research, product analysis, business plans, and other information about the organization.

Information about the employees may be searched and viewed to perform various operations within an organization. For example, if a manager desires to create a job listing for a new position, the manager may review information about current positions in the organization. The manager may search the databases for the organization and identify information about current positions and employees in those positions. This information is used to create the job listing.

However, the information in currently used databases is often in a form that is cumbersome and difficult to analyze and manipulate based on the manner in which responses to queries to the databases are made. As a result, combining of the information may be needed in the analysis of the information, and more time than desired may be needed to obtain desired information or combine the information about the positions and employees from a database in an information system.

Spreadsheets or reports may be created to help in the analysis of information about positions in the organization. Information from a database may be exported to a spreadsheet, and a user may enter or modify the information in the spreadsheet. Spreadsheets may also be merged to combine information. Using spreadsheets to analyze or combine information may still be more difficult and cumbersome than desired.

For example, when identifying information for a job listing, a search is performed for information about people in the same type of position or similar positions in the organization. As the number of people with the same type of position or similar positions increases, the analysis of the information in the spreadsheets becomes more difficult. Further, as the number of skills considered for the positions increases, the analysis of the information also becomes more difficult.

Therefore, it would be desirable to have a method and apparatus that take into account at least some of the issues discussed above, as well as other possible issues. It would be desirable to have a method and apparatus that overcome a technical problem with analyzing information about people in an organization. For example, it would be desirable to overcome a technical problem with analyzing information about skills for people in an organization in performing operations related positions for the organization.

### SUMMARY

In one illustrative example, a method for analyzing skills for people in an organization is provided. A computer system identifies a change in the skills over time for a group of the people in the organization. The computer system identifies a trend in the skills over time based on the change in the skills identified. The computer system displays a visualization of the trend in a graphical user interface on a display system. The visualization is a graphical representation of the trend enabling performing an operation to meet a metric for the organization.

In another illustrative example, a computer system comprises a display system and a skill analyzer in communication with the display system. The skill analyzer identifies a change in skills over time for a group of people in an organization. The skill analyzer identifies a trend in the skills over time based on the change in the skills identified. The skill analyzer identifies a group of desired skills for the organization based on the trend. The skill analyzer displays a visualization of the trend in a graphical user interface on the display system, enabling performing an operation to meet a metric for the organization.

In yet another illustrative example, a computer program product for analyzing skills for people in an organization comprises a computer readable storage media, a first program code, a second program code, a third program code, and a fourth program code. The first program code, stored on the computer readable storage media, identifies a change in the skills over time for a group of the people in the organization. The second program code, stored on the computer readable storage media, identifies a trend in the skills over time based on change in the skills identified. The third program code, stored on the computer readable storage media, identifies a group of desired skills for the organization based on the trend. The fourth program code, stored on the computer readable storage media, displays a visualization of the trend in a graphical user interface, to enable performing an operation to meet a metric for the organization.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of a block diagram of an information environment in accordance with an illustrative embodiment;

FIG. 2 is an illustration of a block diagram of a visualization of a trend in skills in accordance with an illustrative embodiment;

FIG. 3 is an illustration of a visualization of a trend for skills in a word cloud in accordance with an illustrative embodiment;

FIG. 4 is an illustration of a visualization of a trend for skills in a word cloud in accordance with an illustrative embodiment;

FIG. 5 is an illustration of a visualization of words in a word cloud in accordance with an illustrative embodiment;

FIG. 6 is an illustration of a visualization of words in a word cloud in which the size of the words change in accordance with an illustrative embodiment;

FIG. 7 is an illustration of a visualization of words in a word cloud in which the size of the words change in accordance with an illustrative embodiment;

FIG. 8 is an illustration of a visualization of a trend for skills in a word cloud in accordance with an illustrative embodiment;

FIG. 9 is an illustration of a flowchart of a process for analyzing skills for people in an organization in accordance with an illustrative embodiment;

FIG. 10 is an illustration of a flowchart of a process for analyzing skills in accordance with an illustrative embodiment;

FIG. 11 is an illustration of a flowchart of a process for identifying skills in accordance with an illustrative embodiment;

FIG. 12 is an illustration of a flowchart of a process for identifying a trend in skills in accordance with an illustrative embodiment;

FIG. 13 is an illustration of a flowchart of a process for identifying a trend in skills in accordance with an illustrative embodiment;

FIG. 14 is an illustration of a flowchart of a process for displaying a visualization of a trend in a graphical user interface in accordance with an illustrative embodiment; and

FIG. 15 is an illustration of a block diagram of a data processing system in accordance with an illustrative embodiment.

### DETAILED DESCRIPTION

The illustrative embodiments recognize and take into account one or more different considerations. Those embodiments recognize and take into account that analyzing information about employees in an organization may be more difficult than desired. For example, the illustrative embodiments recognize and take into account that in identifying skills for positions in an organization, skills for a particular position may change over time. Knowledge of the change in skills over time for the organization may be useful in making decisions about positions in the organization. For example, this knowledge may be useful in hiring, promotions, reviews, and other operations with respect to positions in the organization.

Thus, the illustrative embodiments provide a method and apparatus for identifying skill shifts. In one illustrative example, a change in the skills over time are identified for a group of people in an organization. As used herein, a “group of,” used with reference to items, is one or more items. For example, a group of people is one or more persons. The change in the skills may be a change in one or more of the skills.

A trend in the skills over time is identified from the changes. The process displays a visualization of the trend in a graphical user interface enabling performing an operation relating to positions for the organization. The process may also identify desired skills for the organization based on the trend.

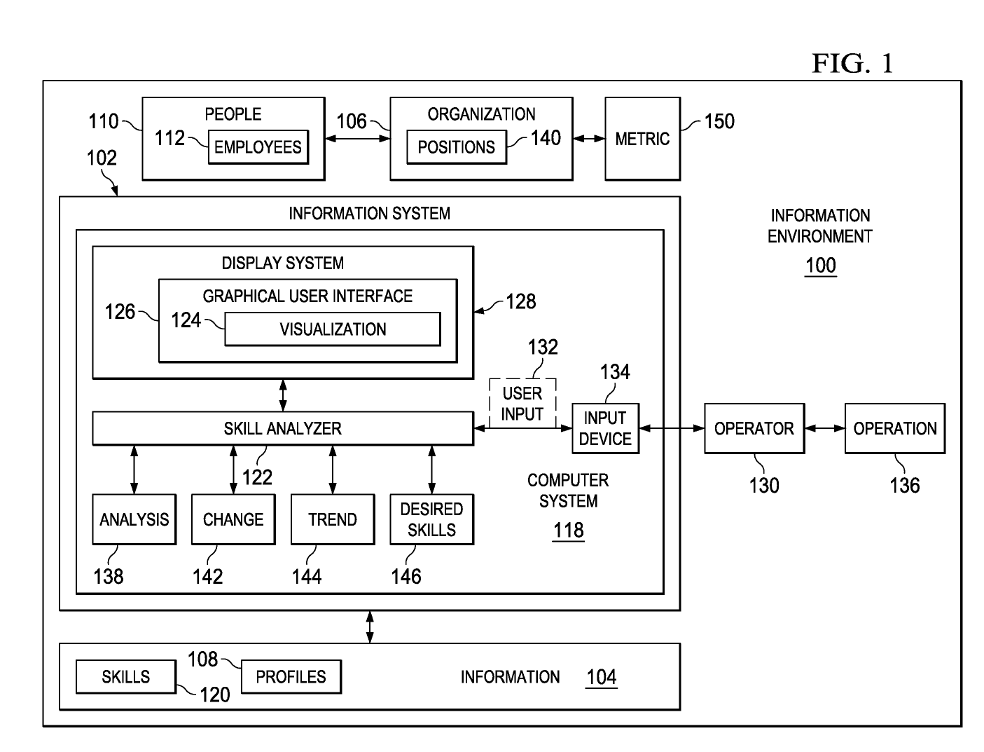

With reference now to the figures and, in particular, with reference to FIG. 1, an illustration of a block diagram of an information environment is depicted in accordance with an illustrative embodiment. In this illustrative example, information environment 100 includes information system 102. Information system 102 provides access to information 104. The access of information 104 may be at least one of reading, writing, modifying, storing, or deleting information 104.

As used herein, the phrase “at least one of,” when used with a list of items, means different combinations of one or more of the listed items may be used and only one of each item in the list may be needed. In other words, “at least one of” means any combination of items and number of items may be used from the list, but not all of the items in the list are required. The item may be a particular object, thing, or a category.

For example, without limitation, “at least one of item A, item B, or item C” may include item A, item A and item B, or item B. This example also may include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

In the illustrative example, information 104 may take different forms. For example, information 104 may be information for at least one of people, products, services, business plans, performance reviews, payroll, human resources, benefits administration, business plans, marketing, research, product development, or other suitable information.

In the illustrative example, information 104 for organization 106 may be, for example, selected from one of a company, a partnership, a corporation, a charity, a city, an educational group, a social group, a team, a government entity, or some other suitable type of organization. People 110 may be employees 112 of organization 106. In other illustrative examples, people 110 may be members of organization 106 without being employees 112.

Information system 102 provides access to information 104. Information 104 may be stored in information system 102, other locations external to information system 102, or some combination thereof. For example, information system 102 may be used for at least one of payroll, human resources, benefits administration, research, product analysis, business planning, product development, marketing, or some other suitable purposes in organization 106.

As depicted, information 104 may include profiles 108 for people 110, such as employees 112, in organization 106. Profiles 108 may be organized in a number of different ways. For example, profiles 108 may be organized in the form of web pages accessed by a web server in computer system 118.

In the illustrative example, profiles 108 include information 104 about people 110 in organization 106. Profiles 108 may include, for example, information 104 such as skills 120 for people 110. Additionally, skills 120 may be found in other locations such as performance reviews, human resource files, or other locations in information system 102.

Computer system 118 is a hardware system and includes one or more data processing systems. When more than one data processing system is present, those data processing systems are in communication with each other using a communications medium. The communications medium may be a network. The data processing systems may be selected from at least one of a computer, a server computer, a tablet, or some other suitable data processing system.

As depicted, skill analyzer 122 performs at least one of identifying skills 120, analyzing skills 120, or displaying skills 120 for people 110. Skill analyzer 122 may be implemented in software, hardware, firmware or a combination thereof. When software is used, the operations performed by skill analyzer 122 may be implemented in program code configured to run on hardware, such as a processor unit. When firmware is used, the operations performed by skill analyzer 122 may be implemented in program code and data and stored in persistent memory to run on a processor unit. When hardware is employed, the hardware may include circuits that operate to perform the operations in skill analyzer 122.

In the illustrative examples, the hardware may take the form of a circuit system, an integrated circuit, an application specific integrated circuit (ASIC), a programmable logic device, or some other suitable type of hardware configured to perform a number of operations. With a programmable logic device, the device may be configured to perform the number of operations. The device may be reconfigured at a later time or may be permanently configured to perform the number of operations. Programmable logic devices include, for example, a programmable logic array, a programmable array logic, a field programmable logic array, a field programmable gate array, and other suitable hardware devices. Additionally, the processes may be implemented in organic components integrated with inorganic components and may be comprised entirely of organic components excluding a human being. For example, the processes may be implemented as circuits in organic semiconductors.

Further, skill analyzer 122 may provide visualization 124 of information 104 in graphical user interface 126 on display system 128 for computer system 118. Display system 128 is a physical hardware system and includes one or more display devices on which graphical user interface 126 may be displayed. The display devices may include at least one of a light emitting diode display (LED), a liquid crystal display (LCD), an organic light emitting diode display (OLED), or some other suitable device on which graphical user interface 126 can be displayed.

Operator 130 is a person that may interact with graphical user interface 126 through user input 132 generated by input device 134 in computer system 118. Input device 134 may be, for example, a mouse, a keyboard, a trackball, a touchscreen, a stylus, a motion sensing input device, a cyberglove, or some other suitable type of input device.

During operation, skill analyzer 122 provides visualization 124 of information 104 in graphical user interface 126 on display system 128. Skill analyzer 122 is in communication with display system 128. In other words, skill analyzer 122 sends data for visualization 124 that is displayed by display system 128.

With visualization 124 in graphical user interface 126, operator 130 may perform operation 136. Visualization 124 may be selected from at least one of skills 120, analysis 138 of skills 120, or some other suitable information about skills 120.

As depicted in this illustrative example, operation 136 is for positions 140 in organization 106. For example, operation 136 may be selected from operations including hiring a person, creating a new position, modifying a position, forming a team, selecting education for the group of people, identifying requirements for a new position, forming a department, performing a review, or some other suitable types of operations.

As depicted, skill analyzer 122 identifies change 142 in skills 120 over time for a group of people 110 in organization 106. The group of people 110 may be, for example, a team, a department, a division, people in a building, or some other selection that groups people 110. Change 142 in skills 120 may be a change in one or more of skills 120.

Skill analyzer 122 identifies trend 144 in skills 120 over time based on change 142 in skills 120 identified. Trend 144 is a direction of change 142 in one or more of skills 120 over time. The direction of trend 144 may be, for example, an increase in the number of people 110 who have a particular skill in skills 120. As another example, trend 144 in skills 120 may be change 142 in a level of skill for one or more of skills 120 in a particular direction.

In the illustrative example, trend 144 is an example of analysis 138. Skill analyzer 122 identifies a group of desired skills 146 for organization 106 based on trend 144. This identification may be a prediction on which ones of skills 120 are desired for performing operations in organization 106.

As depicted, operation 136 is performed based on the need for the group of desired skills 146. As depicted, operation 136 enables meeting metric 150 for organization 106. Metric 150 may be a metric with respect to positions 140. For example, metric 150 may be selected from one of cost savings, employee reductions, a budget, an efficiency level, profitability, productivity, sales, product development, or some other suitable metric.

In the illustrative example, identifying operation 136 is aided by displaying visualization 124 of trend 144 in graphical user interface 126. Visualization 124 of trend 144 is a graphical visualization and is more than a display of text or numbers. Visualization 124 uses a graphical representation of trend 144 that provides an increased comprehension, a faster comprehension, a more complete view, or some combination thereof for information 104 with respect to trend 144 for skills 120 as compared to a non-graphical display.

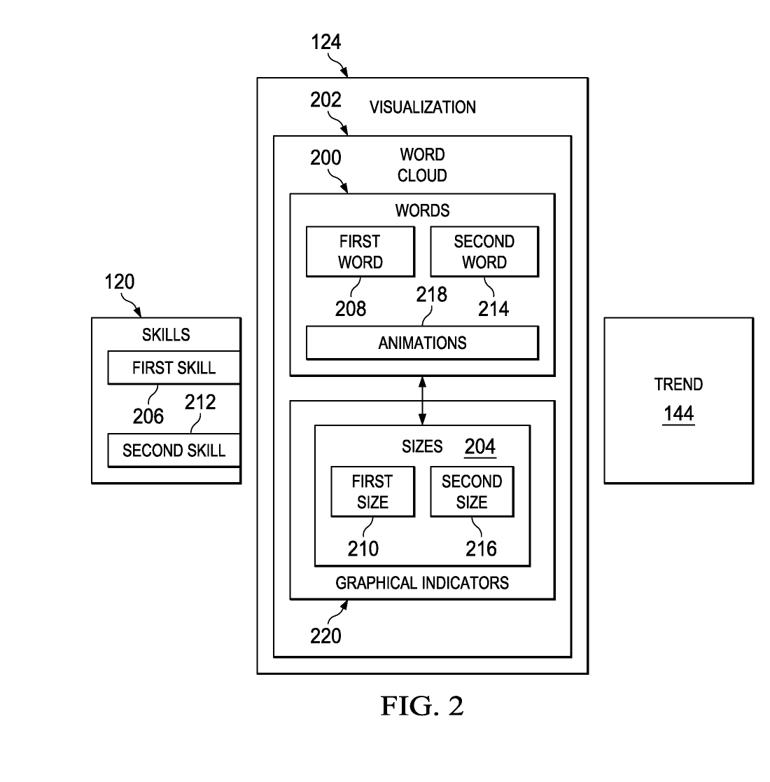

With reference now to FIG. 2, an illustration of a block diagram of a visualization of a trend in skills is depicted in accordance with an illustrative embodiment. In the illustrative examples, the same reference numeral may be used in more than one figure. This reuse of a reference numeral in different figures represents the same element in the different figures. In the illustrative example, an example of one implementation for visualization 124 is shown.

Displaying visualization 124 for trend 144 in graphical user interface 126 comprises displaying words 200 representing skills 120 in word cloud 202. As depicted, words 200 have sizes 204 based on trend 144 for skills 120.

For example, first skill 206 in skills 120, represented by first word 208 in words 200, has first size 210 in sizes 204, relative to second skill 212 in skills 120, represented by second word 214 in words 200 that has second size 216. If trend 144 for first skill 206 is that first skill 206 is increasing in people 110, and trend 144 for second skill 212 is that second skill 212 remains the same or is decreasing in people 110, then first size 210 for first word 208 is larger than second size 216 for second word 214.

In other words, sizes 204 represent trend 144 for skills 120, represented by words 200. Sizes 204 do not represent the number of people 110 having skills 120. Rather, sizes 204 for words 200 represent what direction of change 142 is occurring for skills 120.

In the illustrative example, displaying words 200 representing skills 120 in word cloud 202 may comprise displaying animations 218 of words 200 in word cloud 202 that reflects trend 114 in skills 120 over time. In other words, for example, skill analyzer 122 may display animations 218 showing changes in sizes 204 for words 200 over time to reflect the change in skills 120 over time. In another example, the animations may be changes in color, font, amount of bolding, or other changes of the manner in which words 200 are displayed in word cloud 202 that show how skills 120, represented by words 200, change over time. In other words, animations 218 changes over time to reflect trend 144 for skills 120.

For example, if first skill 206 increases and second skill 212 remains the same over time, first size 210 for first word 208 increases in size over time while second size 216 for second word 214 remains the same size over time in animations 218. If second skill 212 decreases, second size 216 for second word 214 decreases in size over time in animations 218.

In the illustrative example, sizes 204 and animations 218 for words 200 in word cloud 202 are examples of graphical indicators 220 that may be assigned to words 200 to indicate trend 144 for skills 120 represented by words 200. Graphical indicators 220 may be other types of graphical indicators in addition to or in place of sizes 204 and animations 218. For example, graphical indicators 220 assigned to words 200 may be selected from at least one of size, animations 218, a location of the word, a color, a font, bolding, or some other graphical indicator that indicates the manner in which words 200 are to be displayed in word cloud 202.

In the illustrative example, skill analyzer 122 in computer system 118 makes information system 102 a skill shift visualization system. This type of system aids operator 130 in visualizing trend 144 in skills 120 to identify and perform operation 136 for organization 106. The operation is with respect to positions 140 in organization 106.

In one illustrative example, one or more technical solutions are present that overcome a technical problem with analyzing information 104 about skills 120 for people 110 in organization 106 in performing operation 136 related to positions 140 in organization 106. One or more technical solutions identify trend 144 for skills 120. One or more technical solutions provide visualization 124 of trend 144. As a result, one or more technical solutions may provide a technical effect in which at least one of desired skills 146 may be identified, increase the ease of comprehending trend 144, facilitate identifying operation 136, or other technical effects relating to organizations, such as technical effects relating to positions 140 in organization 106.

As a result, computer system 118 operates as a special purpose computer system in which skill analyzer 122 in computer system 118 enables identifying trend 144 in skills 120 and providing visualization 124 of trend 144. In particular, skill analyzer 122 transforms computer system 118 into a special purpose computer system as compared to currently available general computer systems that do not have skill analyzer 122.

Computer system 118 with skill analyzer 122 performs a transformation of data such as identifying trend 144 in skills 120 in information 104. Additionally, the transformation of data includes transforming information 104 into visualization 124 displayed in graphical user interface 126 on display system 128 to operator 130. In this manner, skills 120 in information 104 may be transformed into data such as trend 144 that is displayed in visualization 124 to operator 130. As a result, information 104, such as profiles 108 typically used to find information about people 110 in organization 106, may be transformed into trend 144 for skills 120. The transformation of data may further include generating visualization 124 for trend 144 for skills 120.

The illustration of information environment 100 in FIG. 1 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, profiles 108 may include other information other than skills 120. Profiles 108 may include location, phone number, email address, personal information, images, interests, patents in which people 110 are inventors, technical papers authored by people 110, and other suitable information about people 110.

In another illustrative example, skills 120 may be in locations remote to computer system 118 for organization 106. For example, skills 120 may be found on other computer systems for social networking websites, professional networking websites, published documents, and other suitable locations that may be accessed by computer system 118. In another illustrative example, people 110 may be people in additional to or in place of those in organization 106. For example, people 110 may include people in another organization or people not belonging to an organization.

As another example, displaying visualization 124 of trend 144 in graphical user interface 126 may take other forms other than words 200 in word cloud 202. For example, visualization 124 occurs through displaying a line graph showing trend 144 for skills 120 over time. In another example, operation 136 includes creating a strategy for organization 106 based on trend 144 identified for skills 120.

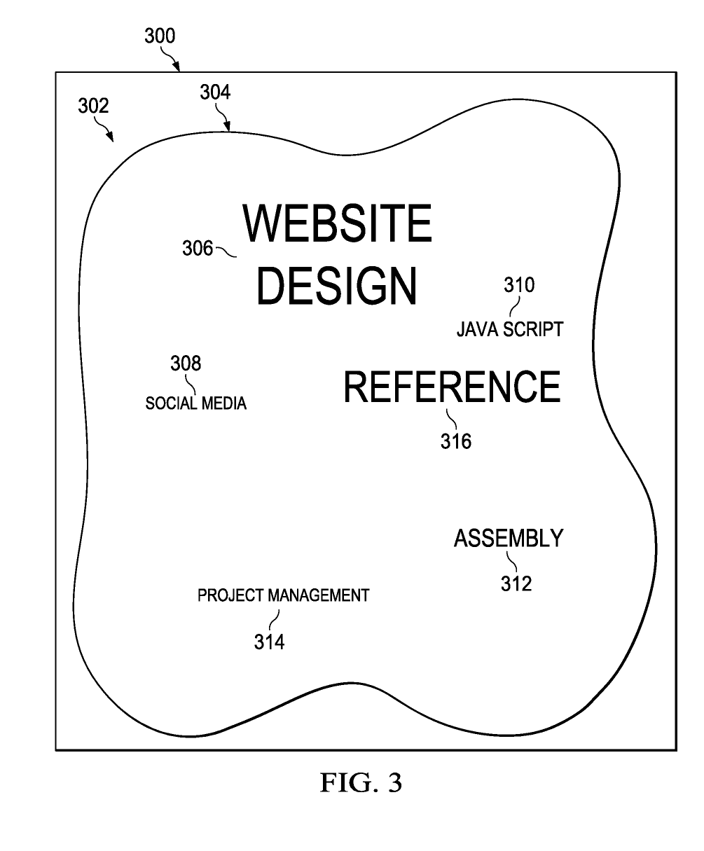

Turning now to FIGS. 3-8, illustrations of visualizations of trends for skills using size are depicted in accordance with an illustrative embodiment. Turning first to FIG. 3, an illustration of a visualization of a trend for skills in a word cloud is depicted in accordance with an illustrative embodiment. As depicted, visualization 300 is an example of an implementation of visualization 124 displayed in graphical user interface 126 on display system 128 in FIG. 1.

In this illustrative example, words 302 in word cloud 304 is an example of an implementation for words 200 in word cloud 202 shown in block form in FIG. 2. As depicted, in visualization 300, words 302 have sizes in word cloud 304 that indicate the trend of the skills represented by words 302. As depicted, the sizes are the graphical indicators of the trend for skills represented by words 302.

As depicted, words 302 include Website Design 306, Social Media 308, Java Script 310, Assembly 312, Project Management 314, and Reference 316. Reference 316 is a reference word that may be used for comparison to determine whether a skill represented in words 302 has an increasing trend or a decreasing trend. If the word has a size that is larger than the size of Reference 316, the skill has an increasing trend. If the word has a size that is smaller than the size of Reference 316, the skill has a decreasing trend. If the word has a size that is the same size of Reference 316, the skill is static and does not have an increasing or a decreasing trend.

For example, Website Design 306 represents a skill for designing web sites. In this example, Website Design 306 has a size that is larger than size of Reference 316, indicating Website Design 306 is increasing as a skill for the people in an organization. As another example, Assembly 312 has a size that is smaller than the size of Reference 316, indicating a decreasing trend for the skill for programming in assembly language.

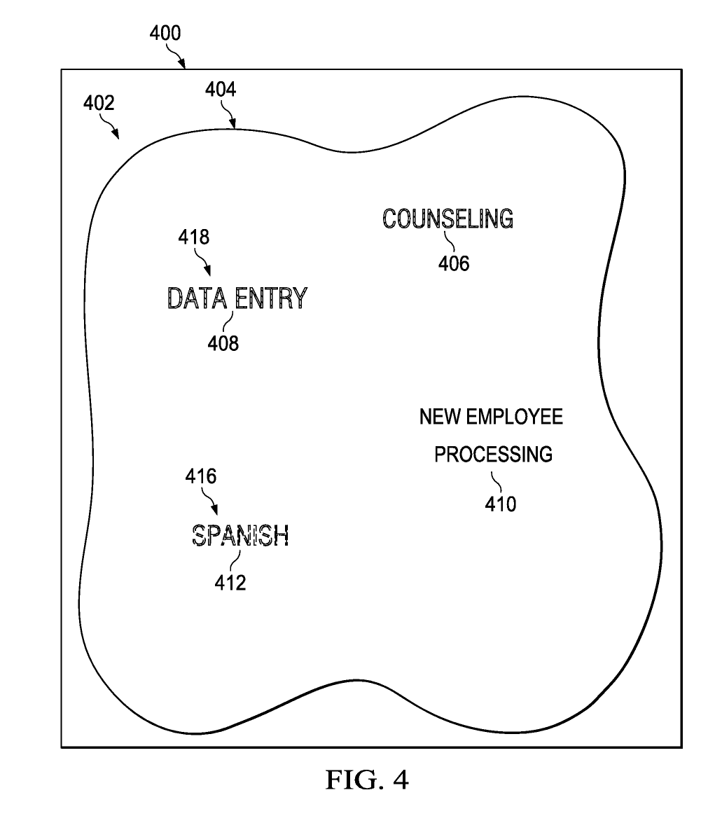

Turning now to FIG. 4, an illustration of a visualization of a trend for skills in a word cloud is depicted in accordance with an illustrative embodiment. As depicted, visualization 400 is an example of an implementation of visualization 124 displayed in graphical user interface 126 on display system 128 in FIG. 1.

In this example, words 402 in word cloud 404 have colors that indicate the trend for the skills represented by words 402. Words 402 include Counseling 406, Data Entry 408, New Employee Processing 410, and Spanish 412.

For example, Spanish 412 in words 402 has color 416, indicating an increasing trend in the skill for the Spanish as language skill. Data Entry 408 has color 418, indicating the skill of entering data has a decreasing trend.

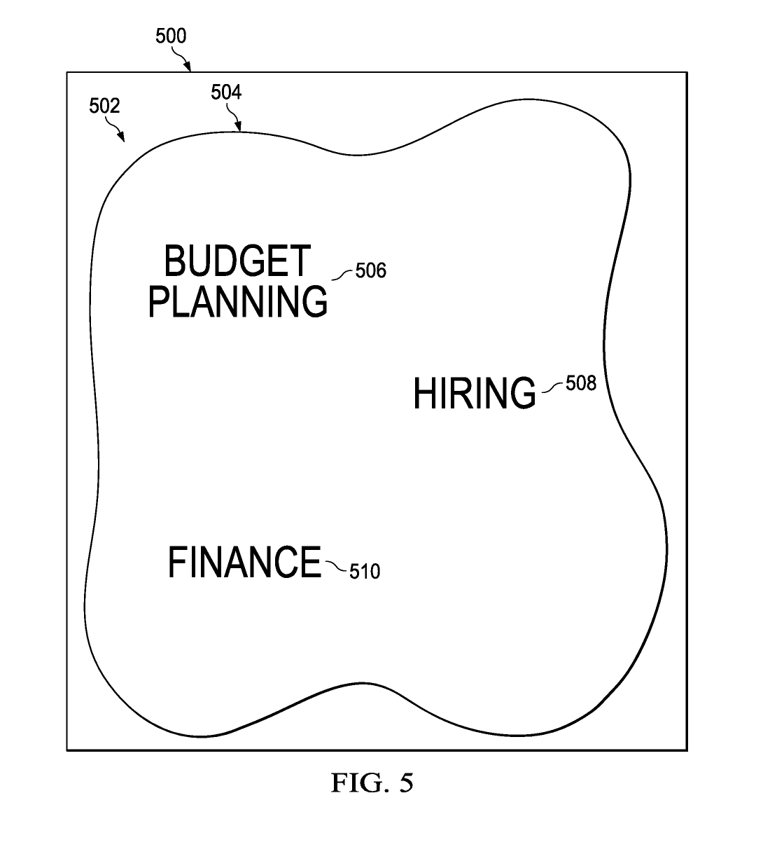

With reference next to FIGS. 5-7, illustrations of visualizations of a trend for skills in a word cloud using animations are depicted in accordance with an illustrative embodiment. Turning first to FIG. 5, an illustration of a visualization of words in a word cloud is depicted in accordance with an illustrative embodiment. In this illustrative example, visualization 500 is another example of an implementation of visualization 124 displayed in graphical user interface 126 on display system 128 in FIG. 1. Animations of words 502 in word cloud 504 are used as the graphical indicators to indicate the trend of the skills represented by words 502.

In this depicted example, words 502 include Budget Planning 506, Hiring 508, and Finance 510. Animations of the sizes of words 502 are used to indicate the trend of the skills represented by words 502. The animations are over time.

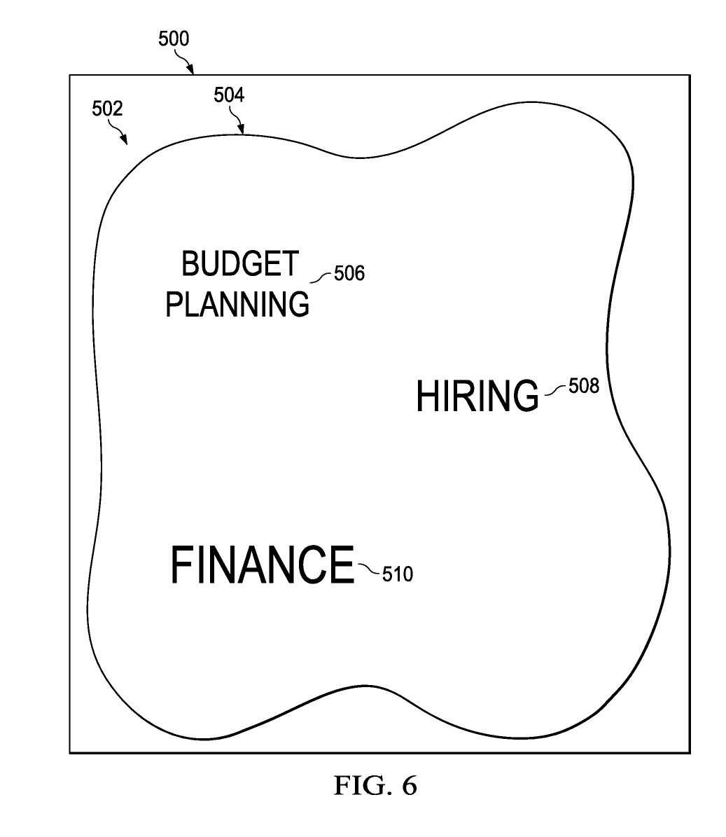

With reference next to FIG. 6, an illustration of a visualization of words in a word cloud in which the size of the words change is depicted in accordance with an illustrative embodiment. In this figure, visualization 500 occurs any time later than visualization 500 in FIG. 5. As depicted, visualization 500 shows that Budget Planning 506 is smaller in size compared to the display of this word in FIG. 5. Hiring 508 has remained the same size as compared to the display of this word in FIG. 5. As depicted, Finance 510 has increased in size from the display of Finance 510 in FIG. 5.

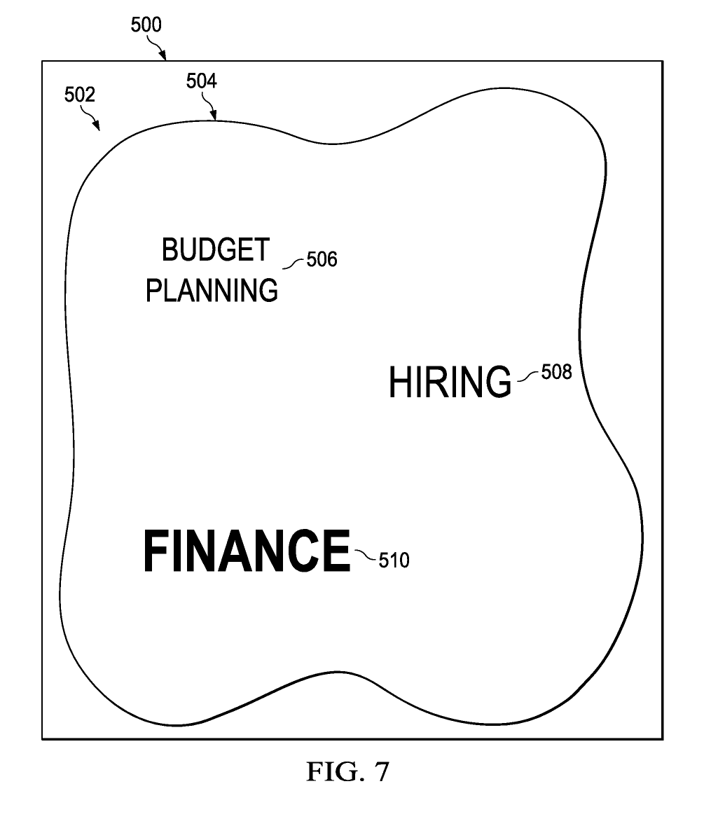

In FIG. 7, an illustration of a visualization of words in a word cloud in which the size of the words change is depicted in accordance with an illustrative embodiment. Visualization 500 in FIG. 7 occurs any time later than visualization 500 as shown in FIG. 6.

As depicted, Budget Planning 506 has decreased in size as compared to the display of this word in FIG. 6. Hiring 508 has remained the same size. Finance 510 has further increased in size from the display of Finance 510 in FIG. 6.

The changes in the size of words 502 in word cloud 504 as displayed in visualization 500 change over time to show the trend of the skills represented by these words as animations. In this illustrative example, the decrease in size for Budget Planning 506 in FIGS. 5-7 indicates that the skill represented by this word has a decreasing trend. Hiring 508 has remained the same size in FIGS. 5-7 indicating that the trend for hiring 508 is no change for the skill presented by this word. In some cases, this situation may be characterized as having an absence of a trend. The increase in size of Finance 510 in FIGS. 5-7 indicates an increasing trend for the skill represented by Finance 510.

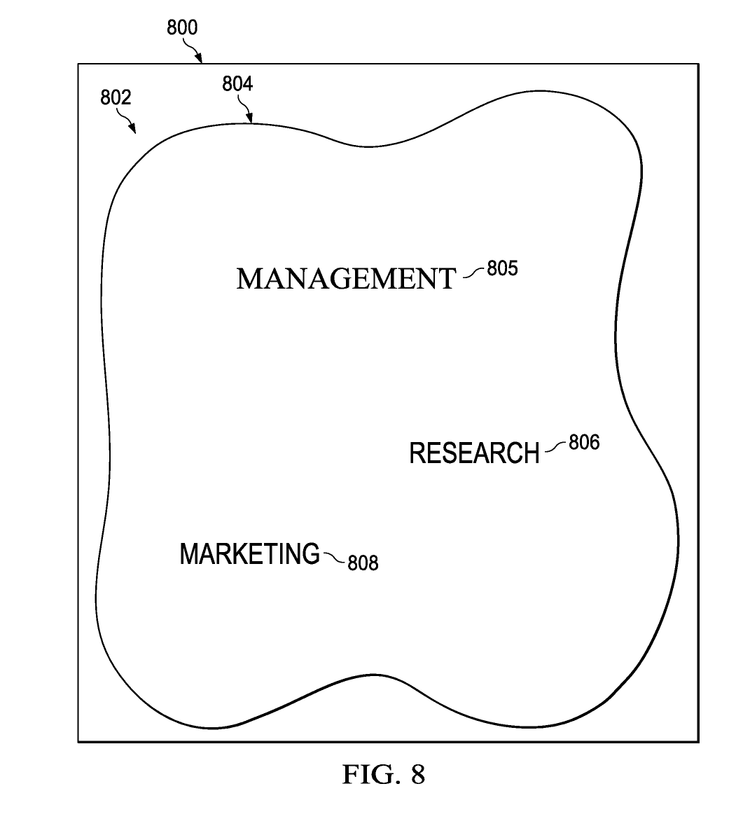

Turning to FIG. 8, an illustration of a visualization of a trend for skills in a word cloud is depicted in accordance with an illustrative embodiment. As depicted, visualization 800 is an example of an implementation of visualization 124 display in graphical user interface 126 on display system 128 in FIG. 1.

In this illustrative example, words 802 in word cloud 804 in visualization 800 include management 805, research 806, and marketing 808. As depicted in visualization 800, the graphical indicators include type of font and font size.

Management 805 has a serif font, while research 806 and marketing 808 have a sans serif font. In this illustrative example, the serif font indicates an increasing trend, and the sans serif font indicates a decreasing trend for the skills represented by words 802. As shown in this illustrative example, research 806 has a smaller size as compared to marketing 808. This difference in size indicates that research 806 has a larger decreasing trend than marketing 808.

The illustration of the graphical indicators used to show trends for skills in FIGS. 3-8 are presented for purposes of illustrating some implementations of graphical indicators that may be assigned to words for showing the trend of the skills represented by those words. These examples are not meant to limit the manner in which other illustrative examples may be implemented. For example, in another illustrative example, the graphical indicator may be the position of the words within the word cloud. For example, words closer to the right side of the word cloud may have an increasing trend while words closer to the left side of the word cloud have a decreasing trend. Further, bolding, underlining, italics, crosshatching, and other graphical indicators may be assigned to words to indicate the trend of skills represented by the words.

Further, these trends may indicate how many people have a skill, the level of skill, or factors with respect to skills that may have trends. The different visualizations in FIGS. 3-8 are for a group of people 110. This group may include one or more people. The group may be a team, a department, a division, people in a building, or some other suitable grouping of people 110.

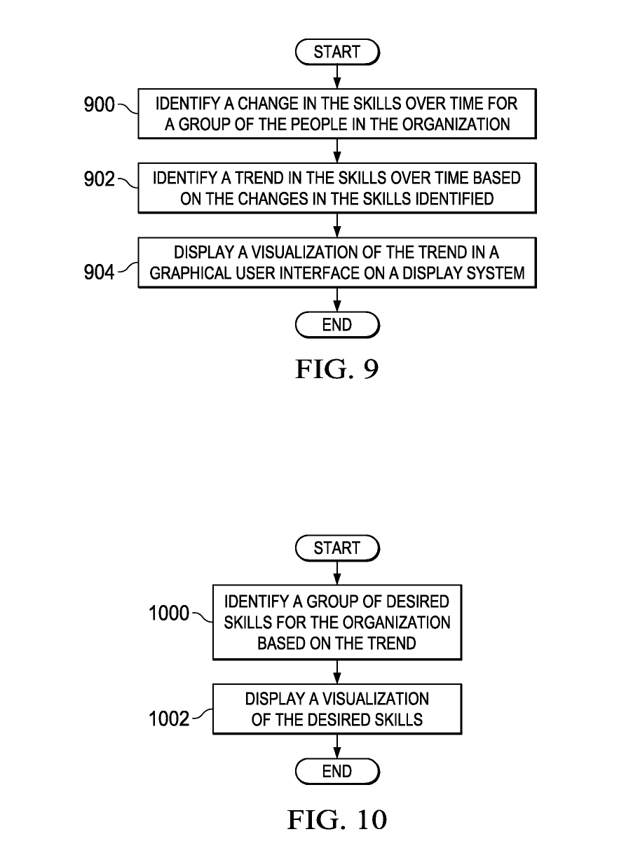

Turning next to FIG. 9, an illustration of a flowchart of a process for analyzing skills for people in an organization is depicted in accordance with an illustrative embodiment. The process illustrated in FIG. 9 may be implemented in information environment 100 in FIG. 1. For example, the process may be implemented in skill analyzer 122 in information system 102 in FIG. 1. The different steps shown in this flowchart may be implemented in program code run by a processor unit, hardware, or some combination thereof.

The process begins by identifying a change in the skills over time for a group of the people in the organization (step 900). The process identifies a trend in the skills over time based on the changes in the skills identified (step 902). The trend includes an identification of the direction of change in the skills.

The process displays a visualization of the trend in a graphical user interface on a display system (step 904) with the process terminating thereafter. The process enables performing an operation for the organization. The operation may meet a metric for the organization.

With reference to FIG. 10, an illustration of a flowchart of a process for analyzing skills is depicted in accordance with an illustrative embodiment. The process illustrated in FIG. 10 may be implemented in information environment 100 in FIG. 1. For example, the process may be implemented in skill analyzer 122 in information system 102 in FIG. 1. The different steps shown in this flowchart may be implemented in program code run by a processor unit, hardware, or some combination thereof.

The process identifies a group of desired skills for the organization based on the trend (step 1000). In step 1000, the desired skill may be identified in a number of different ways.

For example, a skill in the group of desired skills may be identified as a skill that has a trend of increasing in people in selected performance reviews. A selected performance review may be, for example, a performance review that ranks in the top 5 percent, top 10 percent, or some other metric that identifies success in the organization. In another example, the desired skill in the group of desired skills may be identified based on the trend itself. For example, the skill may be one that is increasing in the organization at some selected rate.

The process displays a visualization of the desired skills (step 1002). The process terminates thereafter. With the visualization, an operation may be performed based on the need for the group of desired skills. The operation enables meeting a metric for the organization. For example, the operation may be sending a request for a new position, based on user input from an operator, identifying a team using the desired skills, or other suitable operations.

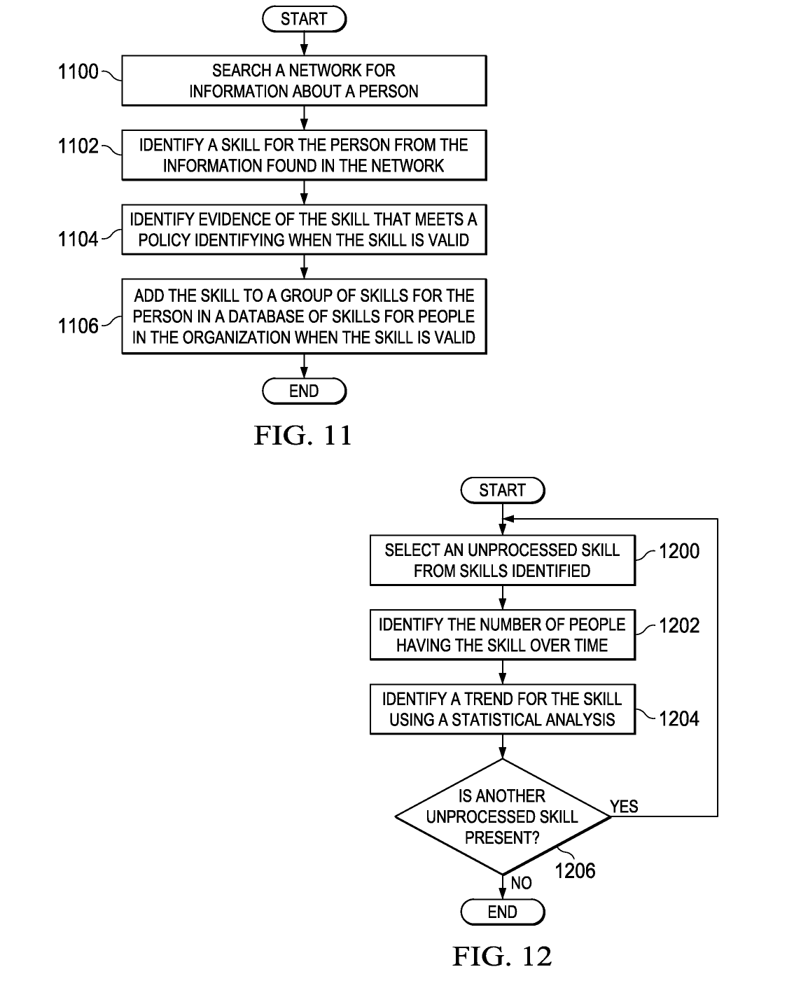

Turning next to FIG. 11, an illustration of a flowchart of a process for identifying skills is depicted in accordance with an illustrative embodiment. The process illustrated in FIG. 11 may be implemented in information environment 100 shown in block form in FIG. 1. This process may be used to enable operations for organization 106. In particular, the process may be implemented in skill analyzer 122 in computer system 118.

The process begins by searching a network for information about a person (step 1100). The network may take different forms. For example, the network, may be at least one of a local area network (LAN), a wide area network (WAN), the Internet, an intranet, or some other suitable type of network.

The process then identifies a skill for the person from the information found in the network (step 1102). The process identifies evidence of the skill that meets a policy identifying when the skill is valid (step 1104). Evidence of a skill meets a policy when the skill is valid. When the skill is valid, the skill may be relied on in identifying a trend for skills in this illustrative example.

The identification of the evidence may be made in a number of different ways, including searching the network. In searching the network, a search of information may be performed for evidence. In other illustrative examples, the evidence may also be identified in other ways. For example, the evidence may be found in other locations or in other manners other than searching network. If the skill is identified through an endorsement found in the information, a request may be made to the endorser for verification of the endorsement. Additionally, the credentials of the endorser also may be examined to determine whether the endorser is considered credible based on the policy.

The policy is a group of rules. The policy also may include data used to apply the group of rules. The policy defines what evidence is needed to consider a skill to be valid for use in the analysis by a skill analyzer.

The process adds the skill to a group of skills for the person in a database of skills for people in the organization when the skill is valid (step 1106) with the process terminating thereafter. In this manner, performing an operation in the organization based on the skills for the people in the organization is enabled by identifying skills that may be relied on in identifying and generating a visualization of a trend of skills.

With reference now to FIG. 12, an illustration of a flowchart of a process for identifying a trend in skills is depicted in accordance with an illustrative embodiment. The process illustrated in FIG. 12 is an example of one implementation for step 902 in FIG. 9.

The process begins by selecting an unprocessed skill from skills identified (step 1200). The process identifies the number of people having the skill over time (step 1202). In this example, the trend is based on how many people have the skill. The process then identifies a trend for the skill using a statistical analysis (step 1204). In step 1204, the statistical analysis may be selected from at least one of a Mann-Kendall test, a moving average, a Kalman filter, or other suitable types of analysis that can be used to identify a trend in the skills.

A determination is made as to whether another unprocessed skill is present (step 1206). If another unprocessed skill is present, the process returns to step 1200. Otherwise, the process terminates.

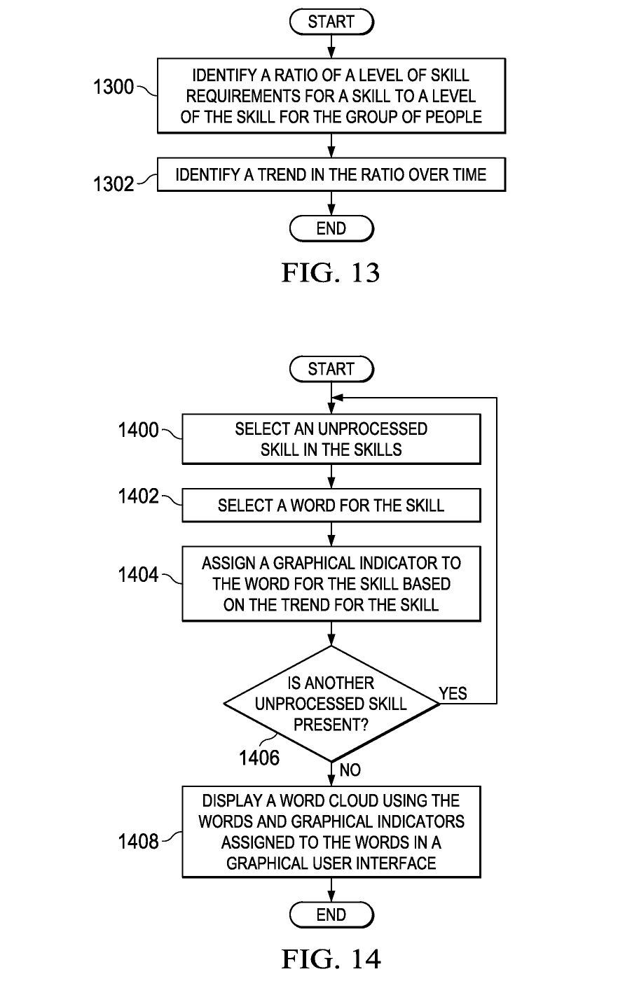

Turning next to FIG. 13, an illustration of a flowchart of a process for identifying a trend in skills is depicted in accordance with an illustrative embodiment. The process illustrated in FIG. 13 is an example of one implementation of step 902 in FIG. 9.

The process begins by identifying a ratio of a level of skill requirements for a skill to a level of the skill for the group of people (step 1300). The process then identifies a trend in the ratio over time (step 1302). The process terminates thereafter.

Turning now to FIG. 14, an illustration of a flowchart of a process for displaying a visualization of a trend in a graphical user interface is depicted in accordance with an illustrative embodiment. The process in FIG. 14 is an example of an implementation of step 904 in FIG. 9.

The process begins by selecting an unprocessed skill in the skills (step 1400). The process selects a word for the skill (step 1402). The word is selected to be descriptive or otherwise indicate the skill in this example.

The process assigns a graphical indicator to the word for the skill based on the trend for the skill (step 1404). The graphical indicator may be selected from at least one a size, a location of the word, a color, a font, bolding, an animation, or some other graphical indicator that indicates the manner in which the word is to be displayed in the word cloud.

The process determines whether another unprocessed skill is present (step 1406). If another unprocessed word is present, the process returns to step 1400.

Otherwise, the process displays a word cloud using the words and graphical indicators assigned to the words in a graphical user interface (step 1408). The process terminates thereafter.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks may be implemented as program code, hardware, or a combination of the program code and hardware. When implemented in hardware, the hardware may, for example, take the form of integrated circuits that are manufactured or configured to perform one or more operations in the flowcharts or block diagrams. When implemented as a combination of program code and hardware, the implementation may take the form of firmware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

For example, in step 1202 in FIG. 12, the process identifies the number of people having the skill over time such that the trend is based on how many people have the skill. In other examples, step 1202 may identify the level of skill in addition to the number of people who have the skill.

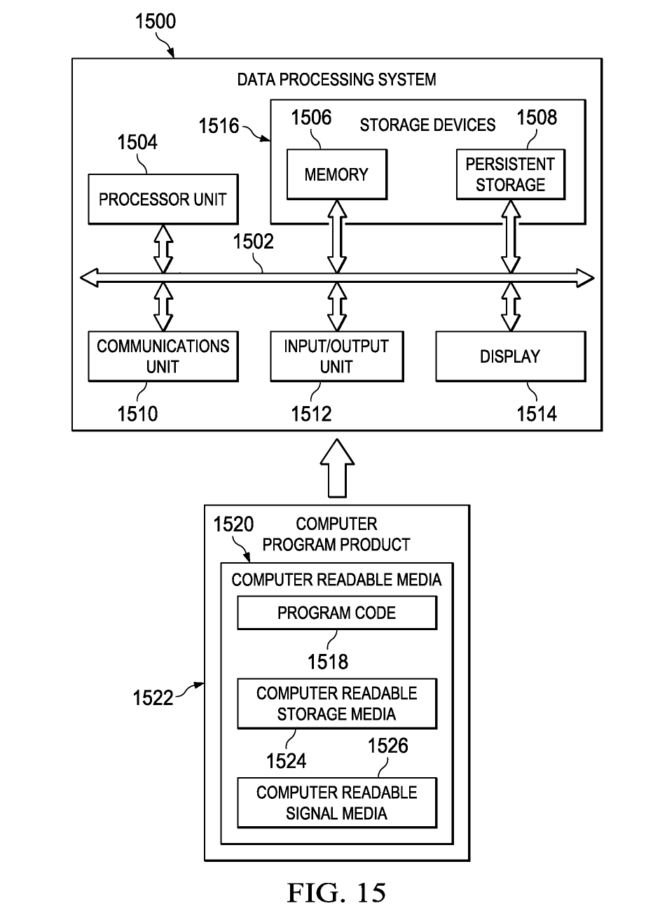

Turning now to FIG. 15, an illustration of a block diagram of a data processing system is depicted in accordance with an illustrative embodiment. Data processing system 1500 may be used to implement computer system 118 in FIG. 1. In this illustrative example, data processing system 1500 includes communications framework 1502, which provides communications between processor unit 1504, memory 1506, persistent storage 1508, communications unit 1510, input/output (I/O) unit 1512, and display 1514. In this example, communication framework may take the form of a bus system.

Processor unit 1504 serves to execute instructions for software that may be loaded into memory 1506. Processor unit 1504 may be a number of processors, a multi-processor core, or some other type of processor, depending on the particular implementation.

Memory 1506 and persistent storage 1508 are examples of storage devices 1516. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 1516 may also be referred to as computer readable storage devices in these illustrative examples. Memory 1506, in these examples, may be, for example, a random access memory or any other suitable volatile or non-volatile storage device. Persistent storage 1508 may take various forms, depending on the particular implementation.

For example, persistent storage 1508 may contain one or more components or devices. For example, persistent storage 1508 may be a hard drive, a solid state hard drive, a flash memory, a rewritable optical disk, a rewritable magnetic tape, or some combination of the above. The media used by persistent storage 1508 also may be removable. For example, a removable hard drive may be used for persistent storage 1508.

Communications unit 1510, in these illustrative examples, provides for communications with other data processing systems or devices. In these illustrative examples, communications unit 1510 is a network interface card.

Input/output unit 1512 allows for input and output of data with other devices that may be connected to data processing system 1500. For example, input/output unit 1512 may provide a connection for user input through at least one of a keyboard, a mouse, or some other suitable input device. Further, input/output unit 1512 may send output to a printer. Display 1514 provides a mechanism to display information to a user.

Instructions for at least one of the operating system, applications, or programs may be located in storage devices 1516, which are in communication with processor unit 1504 through communications framework 1502. The processes of the different embodiments may be performed by processor unit 1504 using computer-implemented instructions, which may be located in a memory, such as memory 1506.

These instructions are referred to as program code, computer usable program code, or computer readable program code that may be read and executed by a processor in processor unit 1504. The program code in the different embodiments may be embodied on different physical or computer readable storage media, such as memory 1506 or persistent storage 1508.

Program code 1518 is located in a functional form on computer readable media 1520 that is selectively removable and may be loaded onto or transferred to data processing system 1500 for execution by processor unit 1504. Program code 1518 and computer readable media 1520 form computer program product 1522 in these illustrative examples. In one example, computer readable media 1520 may be computer readable storage media 1524 or computer readable signal media 1526. In these illustrative examples, computer readable storage media 1524 is a physical or tangible storage device used to store program code 1518 rather than a medium that propagates or transmits program code 1518.

Alternatively, program code 1518 may be transferred to data processing system 1500 using computer readable signal media 1526. Computer readable signal media 1526 may be, for example, a propagated data signal containing program code 1518. For example, computer readable signal media 1526 may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

The different components illustrated for data processing system 1500 are not meant to provide architectural limitations to the manner in which different embodiments may be implemented. The different illustrative embodiments may be implemented in a data processing system including components in addition to or in place of those illustrated for data processing system 1500. Other components shown in FIG. 15 can be varied from the illustrative examples shown. The different embodiments may be implemented using any hardware device or system capable of running program code 1518.

Thus, the illustrative example provides a method and apparatus that identifies a trend in skills and provides a visualization of the trend. The visualization of the trend is displayed in a graphical user interface on a display system to an operator. In this manner, the illustrative example provides a technical solution to overcome a technical problem with analyzing information about skills for people in an organization in performing operations related to positions for the organization. In one example, the trend is displayed graphically in a word cloud to provide the visualization. As depicted, at least one of word sizes, animations, or other graphical elements may be used to provide the visualization of the trend for the skills.

The description of the different illustrative embodiments has been presented for purposes of illustration and description, and is not intended to be exhaustive or limited to the embodiments in the form disclosed. The different illustrative examples describe components that perform actions or operations. In an illustrative embodiment, a component may be configured to perform the action or operation described. For example, the component may have a configuration or design for a structure that provides the component an ability to perform the action or operation that is described in the illustrative examples as being performed by the component.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A method analyzing skills for people in an organization, the method comprising:
identifying, by a computer system, a change in the skills over time for a group of the people in the organization;
identifying, by the computer system, a trend in the skills over time based on the change in the skills identified; and
displaying, by the computer system, a visualization of the trend in a graphical user interface on a display system, wherein the visualization is a graphical representation of the trend enabling performing an operation to meet a metric for the organization.

2. The method of claim 1 further comprising:
identifying, by the computer system, a group of desired skills for the organization based on the trend.

3. The method of claim 2 further comprising:
performing the operation based on a need for the group of desired skills.

4. The method of claim 1, wherein identifying, by the computer system, the trend in the skills comprises:
identifying a ratio of a level of skill requirements for a skill to a level of the skill for the group of the people; and
identifying the trend in the ratio over time.

5. The method of claim 1, wherein displaying, by the computer system, the visualization of the trend in the graphical user interface comprises:
displaying words representing the skills in a word cloud, wherein the words have graphical indicators representing the trend for the skills.

6. The method of claim 5, wherein, by the computer system, the visualization of the trend in the graphical user interface comprises:
displaying the words representing the skills in the word cloud, wherein the words have sizes as the graphical indicators representing the trend for the skills.

7. The method of claim 5, wherein displaying the words representing the skills in the word cloud comprises:
displaying animations of the words showing changes in the words over time to reflect the trend for the skills over time, wherein the animations of the words are the graphical indicators representing the trend for the skills.

8. The method of claim 1, wherein displaying, by the computer system, the visualization of the trend in the graphical user interface comprises:
displaying a line graph showing the trend for the skills over time.

9. The method of claim 1, wherein the operation is selected from one of hiring a person, creating a new position, modifying a position, forming a team, selecting education for the group of the people, identifying requirements for a new position, forming a department, or performing a review.

10. A computer system comprising:
a display system; and
a skill analyzer in communication with the display system, wherein the skill analyzer identifies a change in skills over time for a group of people in an organization; identifies a trend in the skills over time based on the change in the skills identified; identifies a group of desired skills for the organization based on the trend; and displays a visualization of the trend in a graphical user interface on the display system, enabling performing an operation to meet a metric for the organization.

11. The computer system of claim 10, wherein the skill analyzer identifies the group of desired skills for the organization based on the trend.

12. The computer system of claim 10, wherein in identifying the trend in the skills, the skill analyzer identifies a ratio of a level of skill requirements for a skill to a level of the skill for the group of the people and identifies the trend in the ratio over time.

13. The computer system of claim 10, wherein, in displaying the visualization of the trend in the graphical user interface, the skill analyzer displays words representing the skills in a word cloud, wherein the words have graphical indicators representing the trend for the skills.

14. The computer system of claim 13, wherein, in displaying the visualization of the trend in the graphical user interface, the skill analyzer displays the words representing the skills in the word cloud, wherein the words have sizes as the graphical indicators representing the trend for the skills.

15. The computer system of claim 13, wherein, in displaying the words representing the skills in the word cloud, the skill analyzer displays an animation showing changes in the words over time to reflect the change in the skills over time, wherein the animation of the words are the graphical indicators representing the trend for the skills.

16. The computer system of claim 10, wherein in displaying the visualization of the trend in the graphical user interface, the skill analyzer displays a line graph showing the trend for the skills over time.

17. The computer system of claim 10, wherein the operation is selected from one of hiring a person, creating a new position, modifying a position, forming a team, selecting education for the group of the people, identifying requirements for a new position, forming a department, or performing a review.

18. A computer program product for analyzing skills for people in an organization, the computer program product comprising:
a computer readable storage media;
first program code, stored on the computer readable storage media, for identifying a change in the skills over time for a group of the people in the organization;
second program code, stored on the computer readable storage media, for identifying a trend in the skills over time based on the change in the skills identified;
third program code, stored on the computer readable storage media, for identifying a group of desired skills for the organization based on the trend; and
fourth program code, stored on the computer readable storage media, for displaying a visualization of the trend in a graphical user interface, enabling performing an operation to meet a metric for the organization.

19. The computer program product of claim 18 further comprising:
fifth program code, stored on the computer readable storage media, for identifying the group of desired skills for the organization based on the trend.

20. The computer program product of claim 18, wherein identifying the second program code comprises:
program code, stored on the computer readable storage media, for identifying a ratio of a level of skill requirements for a skill to a level of the skill for the group of the people; and
program code, stored on the computer readable storage media, for identifying the trend in the ratio over time.

21. The computer program product of claim 18, wherein displaying the fourth program code comprises:
program code, stored on the computer readable storage media, for displaying words representing the skills in a word cloud, wherein the words have graphical indicators representing the trend for the skills.

22. The computer program product of claim 21, wherein the program code, stored on the computer readable storage media, for displaying the words representing the skills in the word cloud, wherein the words have the graphical indicators representing the trend for the skills comprises:
program code, stored on the computer readable storage media, for displaying the words representing the skills in the word cloud, wherein the words have sizes as the graphical indicators representing the trend for the skills.

23. The computer program product of claim 21, wherein the program code, stored on the computer readable storage media, for displaying the words representing the skills in the word cloud, wherein the words have the graphical indicators representing the trend for the skills comprises:
program code, stored on the computer readable storage media, for displaying an animation showing changes in the words over time to reflect the change in the skills over time, wherein the animations of the words are the graphical indicators representing the trend for the skills.

24. The computer program product of claim 18, wherein the fourth program code comprises:
program code, stored on the computer readable storage media, for displaying a line graph showing the trend for the skills over time.

25. The computer program product of claim 18, wherein the operation is selected from one of hiring a person, creating a new position, modifying a position, forming a team, selecting education for the group of the people, identifying requirements for a new position, forming a department, or performing a review.
